(19) United States
(12) Patent Application Publication
(10) Pub. No.: US 2021/0181805 A1
(43) Pub. Date: Jun. 17, 2021

(54) ACCESSORY PIVOTS WITH TRANSFER BARS

(71) Applicant: HEWLETT-PACKARD DEVELOPMENT COMPANY, L.P., Spring, TX (US)

(72) Inventors: Chi-Chung HO, Taipei (TW); Hogan Hote YEH, Taipei (TW); Chen-Fang HSU, Taipei (TW)

(73) Assignee: HEWLETT-PACKARD DEVELOPMENT COMPANY, L.P., Houston, TX (US)

(21) Appl. No.: 16/076,218

(22) PCT Filed: Jul. 3, 2017
(86) PCT No.: PCT/US2017/040581

§ 371 Date: Aug. 7, 2018

(51) Int. Cl. G06F 1/16; F16C 11/04

(52) U.S. Cl. CPC G06F 1/1681; G06F 1/1686; F16C 11/04

(57) ABSTRACT

In an example, an accessory pivot may include a driven gear, which may be fixed or attached to an electronic device accessory, a hinge gear engaged with a hinge of an electronic device, and a transfer bar engaged with the driven gear and the hinge gear. The transfer bar may actuate the driven gear upon the transfer bar being actuated by the hinge gear.

### BACKGROUND

Electronic devices such as computing devices may include or he used in conjunction with computing device accessories. Such accessories may include digital cameras or other computing device accessories. Such accessories may be attached to, disposed within, or otherwise engaged with computing devices, in some situations.

### BRIEF DESCRIPTION OF THE DRAWINGS

FIG. 1 is a perspective view of an example accessory pivot.

FIG. 2A is a perspective view of an example computing device having an example accessory pivot.

FIG. 2B is a perspective view of an example computing device having an example accessory pivot.

FIG. 2C is a detail perspective view of an example accessory pivot.

FIG. 2D is a detail cutaway view of an example accessory pivot.

FIG. 3A is a perspective view of an example computing device having an example accessory pivot.

FIG. 3B is a perspective view of an example computing device having an example accessory pivot.

FIG. 4A is a bottom detail view of an example accessory pivot.

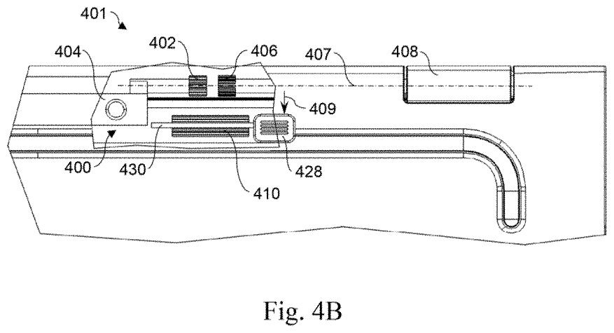

FIG. FIG. 4B is a bottom detail view of an example accessory pivot.

### DETAILED DESCRIPTION

Electronic devices may include or be utilized in conjunction with accessories. Such electronic devices may be computing devices, in some situations, and such accessories may be considered computing device accessories. Such computing device accessories may be integrated into computing devices, or may be attached to or installed on computing devices. In some situations, computing device accessories may be mounted or installed on top of a display of a computing device. Computing device accessories may include digital cameras, video cameras, microphones, electrical connectors or ports, speakers, or other accessories for use with a computing device. As computing devices become smaller, thinner, and/or lighter weight, it may be difficult to mount or install such computing device accessories on top of a display of the computing device or another exterior portion. As such, it may be desirable for a computing device to integrate a computing device accessory into a chassis or housing of the computing device, so that the accessory does not need to be mounted on an external portion of the computing device.

In some situations, it may be desirable to utilize a computing device accessory with a convertible computing device, or, in other words, a computing device which may be used in a clamshell or notebook-style manner, and, alternatively, in a tablet-style manner. It may be difficult to mount or install a computing device accessory on to such a convertible computing device in a way that the computing device accessory may be used with the computing device when the computing device is disposed in both the notebook orientation and in the tablet orientation. Therefore, in sonic situations, it may be desirable to integrate a computing device accessary into a computing device such that the accessory may be utilized with the computing device regardless of the computing device being disposed in a notebook or tablet orientation.

Further, in sonic situations, it may be desirable for a computing device accessory to extend from an edge of the computing device such that the accessory may achieve a large or wide line of sight of the environment within which the computing device may be disposed. It may be difficult to attach a computing device accessory to a computing device such that the accessory extends from the computing device in an appropriate manner due to thinness of the computing device, and/or the convertible nature of the computing device. Therefore, it may also be desirable, in some situations, to enable an integrated computing device accessory to extend from an edge or side of the computing device when such functionality is desired.

Implementations of the present disclosure provide accessory pivots that enable an integrated accessory of an electronic device, for example a computing device accessory, to be used with the electronic device in a convertible manner. Example accessory pivots disclosed herein enable a computing device accessory to automatically deploy for use upon conversion of the computing device from one orientation to another. Additionally, examples of accessory pivots disclosed herein may enable the accessory of the electronic device to pivot from a stowed position to a deployed position, in which the accessory may extend from the electronic device to be able to obtain a desirable line or field of sight.

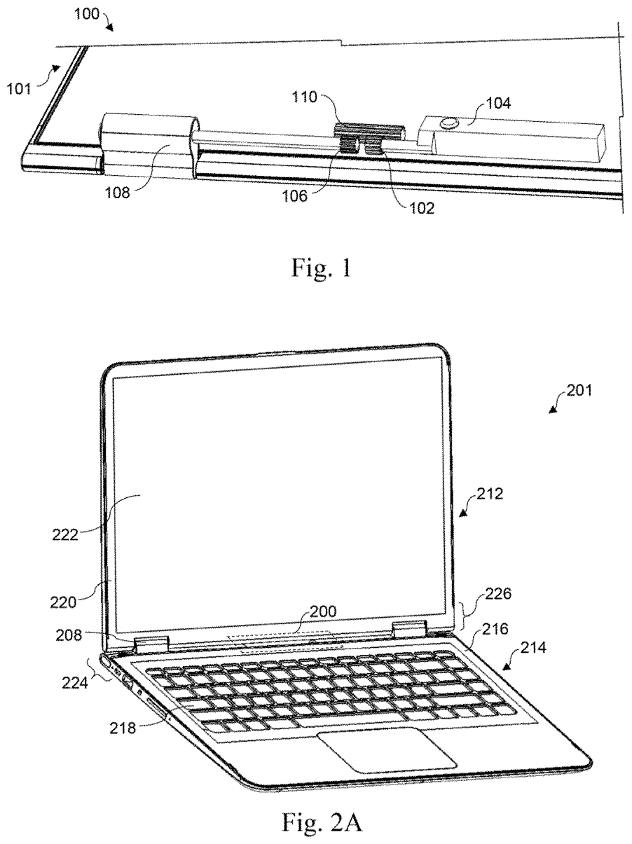

Referring now to FIG. 1, a perspective view of an example accessory pivot 100 is illustrated. In some implementations, the accessory pivot 100 may include a driven gear 102 fixed or otherwise attached to an electronic device accessory 104, a hinge gear 106 engaged with a hinge 108 of an electronic device 101, and a transfer bar 110 engaged with the driven gear 102 and the hinge gear 106 to actuate the driven gear 102 upon the transfer bar 110 being actuated by the hinge gear 106.

In some implementations, the electronic device 101 may be a computing device. The computing device may be a notebook or laptop computer, in some implementations, or may be another type of computing device in other implementations. In further implementations, the electronic device may he a convertible computing device, which may be able to be utilized in a notebook or clamshell-style fashion, resembling a traditional notebook or laptop computer, and also may be physically reoriented to resemble a tablet-style computing device. In order to enable such a switch in physical layout and/or orientation, the computing device 101 may have a hinge or hinges 108 that may allow or enable a display portion of the computing device 101 to rotate relative to and/or around a user input portion of the computing device 101 and to lay against a rear surface of such a user input portion such that the computing device resembles a tablet or slate, in other implementations, electronic device 101 may be another type of electronic device, other than a computing device. It should be noted that, for clarity, only a portion of electronic device 101 is illustrated in FIG. 1. The illustrated portion of the computing device 101 may be a portion of a panel, housing, or other surface of the computing device 101.

The electronic device accessory 104 may be a peripheral device which may be used in conjunction with the electronic device 101. As such, the function of the electronic device accessory 104 may supplement parts of the function or the overall function of the electronic device 101. In implementations Wherein the electronic device 101 is a computing device, the electronic device accessory 104 may be referred to as a computing device accessory. In some implementations, the electronic device accessory 104 may be a digital camera and/or a video camera. In further implementations, the electronic device accessory 104 may be a microphone, a speaker, a connector and/or port, or may be another type of accessory that may be suitable for use with the electronic device 101. In further implementations, the electronic device accessory 104 may be a 180 degree or a 360 degree camera which may be capable of having a field of view of an entire. environment within which the electronic device 101 may be located, or a substantial portion thereof. In other words, such an electronic device accessory may be capable of scanning and/or viewing an entire room, or a significant portion thereof In order to enable such a 180 degree and/or 360 degree viewing function of such an electronic device accessory 104, it may be desirable for the electronic device accessory 104 to extend from an edge or side of the electronic device 101 during operation or utilization of the electronic device accessory 104 in order to prevent obstructing or blocking a viewing angle of the accessory 104.

The example accessory pivot 100 may have a driven gear 102 attached to or fixed to the electronic device accessory 104. The electronic device accessory 104 may be pivot ably attached to or engaged with the electronic device 101, or a frame, chassis, housing, or another portion thereof, and, as such, the driven gear 102 may enable or cause the electronic device accessory 104 to rotate or pivot relative to the electronic device 101. In order to cause such a rotation or pivot, the driven gear 102 may be engaged with another gear, cog, or other transmission component for transmitting motion which may drive or cause motion of the driven gear 102. In some implementations, the driven gear 102 may be directly attached to or fixed to the electronic device accessory 104 so as to effect movement of the accessory. In other implementations, the driven gear 102 may be indirectly engaged with the electronic device accessory 104, for example, through an intermediary component or components such as other gears, belts, chains, gear racks, or other suitable components for transmitting motion to the accessory 104.

The accessory pivot 100 may further include a hinge gear 106. The hinge gear 106 may be directly or indirectly (e.g., through other intermediary components) engaged with a hinge 108 of the electronic device 101. The hinge 108, in some implementations, may be one of multiple hinges of the electronic device 101. Further, the hinge 108 may be a double pivot hinge. In other words, the hinge 108 may have a first pivot attached to a user input portion of the electronic device 101 and may also have a second pivot attached to a display portion of the electronic device 101. The first pivot may also be attached to or engaged with the hinge gear 106 such that rotation of the hinge gear 106 is dependent on rotation of the first pivot. Such a double pivot hinge may enable the display portion to rotate around the user input portion in order to convert the electronic device 101 from a notebook-style computing device to a tablet-style computing device, in some implementations. In further implementations, the double pivot hinge may enable the display portion to rotate about 360 degrees around the user input portion. The hinge gear 106 may be engaged with the hinge 108 such that the hinge gear 106 rotates along with the hinge 108 upon the binge 148 being rotated relative to a portion of the electronic device 101. In some implementations, the hinge gear 106 may rotate with the hinge 108 upon the hinge 108 being rotated relative to the user input portion of the electronic device 101. In some implementations, in order to rotate with the hinge 108, the hinge gear 106 may be fixed to the hinge 108. In further implementations, the hinge gear 106 may be spaced away from the hinge 108 and attached to the hinge through a hinge shaft or drive shaft. In yet further implementations, the hinge gear 106 may be disposed coaxially to a pivot of the hinge 108, e.g., the first pivot attached to the user input portion of the electronic device 101.

The accessory pivot 100 may further include a transfer bar 110. The transfer bar 110 may be a motive or motion-transmitting component such as a gear. Further, the transfer bar 110 may be engaged with, or removably engageable with the driven gear 102 and the hinge gear 106. The transfer bar 110 may transfer motion from the hinge gear 106 to the driven gear 102, in some implementations. Upon the hinge 108 rotating, the hinge gear 106 may also rotate. Such rotation of the hinge gear 106 may be transferred to the transfer bar 110 through operable engagement of the transfer bar 110 with the hinge gear 106. The transfer bar 110 may transfer such motion to the driven gear 102 through operable engagement of the transfer bar 110 with the driven gear 102. The driven gear 102 may transfer such motion to the electronic device accessory 104. Thus, in some implementations of the present disclosure, the accessory pivot 100 may transfer motion from the hinge 108 to the electronic device accessory 104.

In some implementations, the driven gear 102 and/or hinge gear 106 may be spur gears. In further implementations, the transfer bar 110 may also be a spur gear, and, in other implementations, the transfer bar 110 may be a rack gear, and the hinge gear 106 may be or may operate as a pinion gear. In yet further implementations, the hinge gear 106, the driven gear 102, and the transfer bar 110 may all be bevel gears with complementary geometries to each other. Complementary geometries may refer to a physical structure (e.g., bevel angle, number of teeth, diameter) of each of the bevel gears that may enable the bevel gears to operate with one another. It should be noted that, although described and illustrated as gears, any of the driven gear 102, the hinge gear 106, and/or the transfer bar 110 may be another type of transmission component (e.g., a friction wheel or roller). It is contemplated that other implementations of the accessory pivot may include additional gears, cogs, belts, chains, or other motive components to accomplish the transfer of motion from the hinge 108 to the electronic device accessory 104.

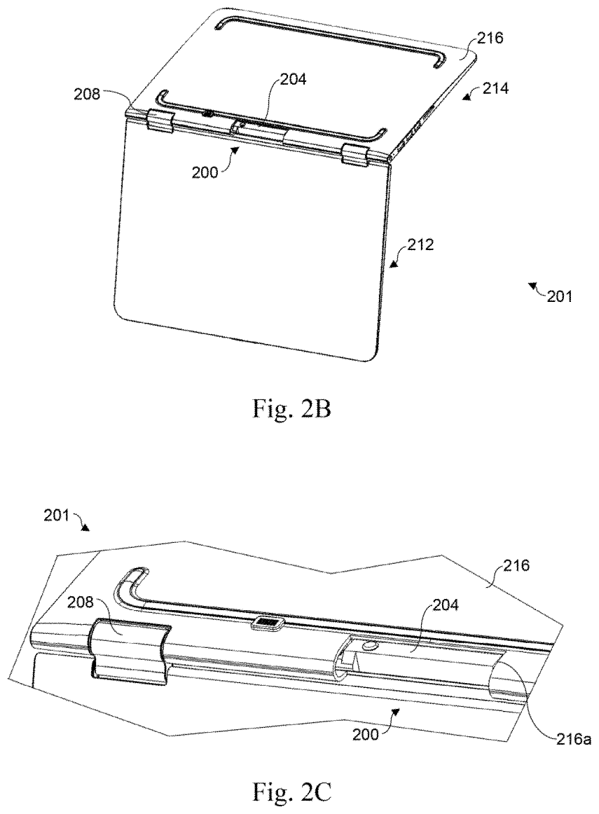

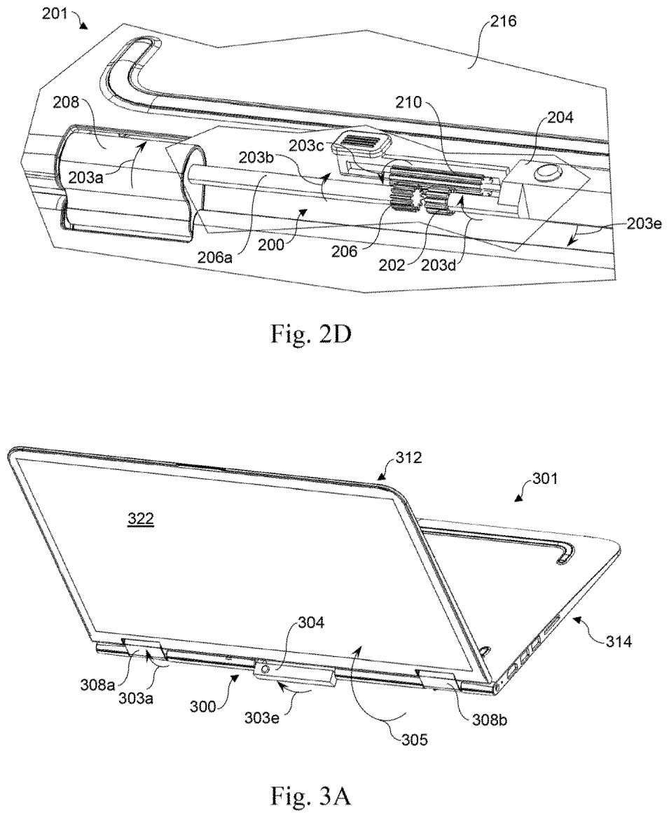

Referring now to FIG. 2A, a perspective view of an example electronic device 201 having an example accessory pivot 200 is illustrated. Example accessory pivot 200 may be similar to other example accessory pivots described above. Further, the similarly-named elements of example accessory pivot 200 may be similar in function and/or structure to the respective elements of other example accessory pivots, as they are described above. Accessory pivot 200 may be disposed within a housing of electronic device 201, and, as such, may be represented by dotted box 200 on FIG. 2A. Further, accessory pivot 200 may be located or disposed in other locations and/or orientations in other implementations.

Electronic device 201 may be a computing device and, as such, may be referred to as computing device 201. Computing device 201 may include a user input portion 214 having a computing device accessory 204, and may also include a display portion 212 pivotably engaged with the user input portion 214. Computing device 201 is illustrated as being disposed or oriented in a clamshell or notebook-style orientation, resembling a notebook computer. Computing device accessory 204 may be a rotatable camera, in some implementations, and may be disposed at a first end 224 of the user input portion 214. Additionally, the user input portion 214 may include user input devices 218, for example, a keyboard, trackpad, and/or other user input devices to enable a user to interact with the electronic device 201. The user input portion 214 may further include a housing 216 within which additional components of the computing device 201 may be disposed. The first end 224 of the user input portion may also be referred to as a first end 224 of the housing 226. The electronic device 201, or the user input portion 214 or the housing 216 thereof, may further include a hinge 208 pivotably engaged with the first end 224 of the housing 216, and pivotally engaged with a base portion 226 of the display portion 212 of the computing device 201. Stated differently, the hinge 208 may be attached to the user input portion 214 at the first end 224, and may be attached to the display portion 212 at the base portion 226. The display portion 212 may also include a display housing 220 and a screen 222 mechanically supported by the display housing 220.

Referring now to FIG. 2B, a perspective view of the example computing device 201 is illustrated wherein the computing device has been flipped to show an underside of the user input portion 214. The computing device 201 is still illustrated as being in a notebook-style orientation. Referring additionally to FIG. 2C, a detail view of the example accessory pivot 200 of the computing device 201 is illustrated. In implementations wherein the computing device accessory 204 is a rotatable camera, the accessory pivot 200 may be referred to as a camera pivot 200. FIG. 2C illustrates a close-up view of a portion of the first end 224 of the housing 216 of the user input portion 214. The computing device accessory 204 may be rotatably disposed within the first end 224 of the housing 216, and is illustrated as being disposed in a stowed position within the housing 216. Further, the housing 216 may include an accessory window 216a. The accessory window 216a may provide clearance for the computing device accessory to rotate or pivot out of the housing 216 to a deployed position so as to extend from a side or edge of the computing device 201. In some implementations, the accessory window 216a may also enable the computing device accessory 204 to at least partially function (e.g., record, scan, and/or take pictures) while still disposed within the housing 216.

Referring now to FIG. 2D, a detail cutaway view of the example accessory pivot 200 is illustrated. A portion of the housing 216 is shown as cut away in order to clearly illustrate the accessory pivot 200 disposed within the first end of the housing 216. The accessory pivot 200 may include a driven gear 202 fixed to or engaged with the computing device accessory 204, a hinge gear 206 engaged with or operably attached to the hinge 208 of the computing device 201, and a transfer bar 210 to actuate the driven gear 202 and rotate the computing device accessory 204 relative to the housing 216 upon the transfer bar 210 being actuated by the hinge gear 206.

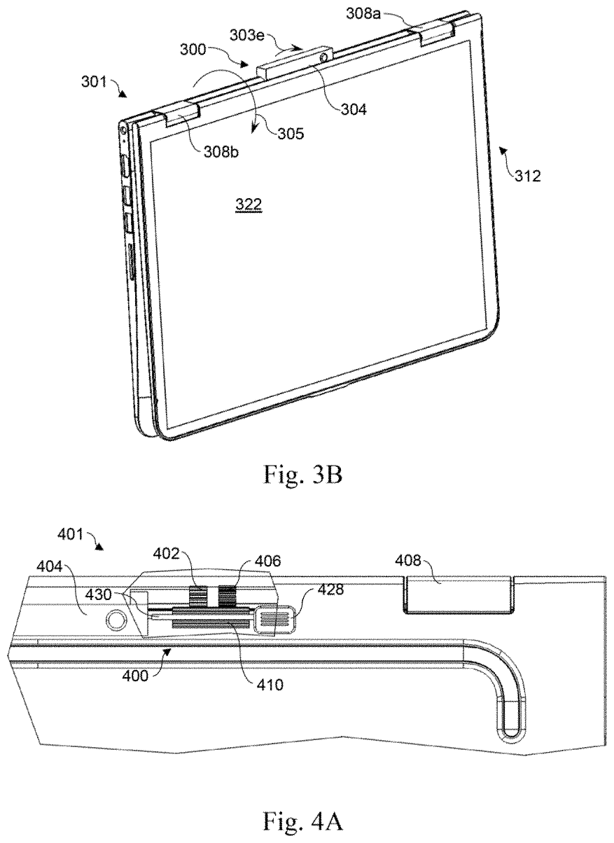

In sonic implementations, the display portion 212 of the computing device 201 may be pivoted or rotated about the hinge 208 relative to the user input portion 214 in order to transition the computing device 201 into a tablet-style use mode. Such a movement of the display portion 212 may cause the hinge 208 to rotate relative to the user input portion 214, or the first end 216 of the housing 214 thereof, in a direction similar to example direction 203a of FIG. 2D. Such a movement of the display is discussed further below with reference to FIGS. 3A-3B, with only the motion direction of the hinge 208 illustrated in FIG. 2D.

In some implementations the hinge gear 206 may be fixed or attached to the hinge 208 so as to not be able to rotate relative to the hinge 208. Thus, movement 203a of the hinge 208 about its pivotable attachment to the user input portion 214 may result in similar corresponding movement 203b of the hinge gear 206, or, in other words, may actuate the hinge gear 206. In some implementations, the hinge gear 206 may be attached to the hinge 208 directly and abut directly against the hinge 208. In other implementations, the hinge gear 206 may be spaced away from the hinge 208 and connected to the hinge 208 using a drive shaft 206a, as illustrated in FIG. 2D. Such a drive shaft 206a may have a sufficient rigidity so as to transfer the motion 203a of the hinge 208 to the hinge gear 206. Thus, in the illustrated example, movement 203b of the drive shaft may also be representative of movement of the hinge gear 206.

The hinge gear 206 may be operably engaged with the transfer bar 210. In this context with reference to any of the hinge gear 206, the transfer bar 210, and or the driven gear 202, operably engaged may refer to a state wherein the respective components, or teeth or contact surfaces thereof, are sufficiently mated, meshed, or contacted in order to produce the transfer of motion from one component to another. As such, when operably engaged, the hinge gear 206 may transfer motion 203b into corresponding motion 203c of the transfer bar 210. In other words, motion of the hinge 208 relative to the first end of the housing 216 may actuate the hinge gear 206 and cause the hinge gear 206 to actuate the transfer bar 210. Note, when considering the hinge gear 206 as being stationary relative to hinge 208, motion 203c of the transfer bar 210 effectively results in the transfer bar 210 moving about the hinge gear 206 and around its circumference or periphery.

Further, when operably engaged, the transfer bar 210 may transfer motion 203c into corresponding motion 203d of the driven gear 202. In other words, the hinge gear 206 may cause the transfer bar 210 to actuate the driven gear 202. Note, in the illustrated example, motion 203b and 203d may be opposite rotational directions to motion 203c. Motion 203d may be transferred by the driven gear 202 to the computing device accessory 204 and result in rotation 203e of the computing device accessory 204. Therefore, operable engagement of the transfer bar 210 with the hinge gear 206 and the driven gear 202 may result in motion being transmitted to the computing device accessory 204 from, ultimately, motion of the hinge 208 relative to the first end of the housing 216.

It should be noted that in other implementations, the hinge gear 206 may have a different movement ratio from the hinge 208. In other words, the hinge gear 206 may be engaged with the hinge 208 through intermediary gearing or other components so as to move or rotate the hinge gear 206 more or less than the hinge 208 may move relative to the user input portion.

Referring now to FIG. 3A, a perspective view of an example computing device 301 having an example accessory pivot 300 is illustrated. Example computing device 301 and accessory pivot 300 may be similar to other example computing devices and accessory pivots described above. Further, the similarly-named elements of computing device 301 and example accessory pivot 300 may be similar in function and/or structure to the respective elements of other example computing devices and accessory pivots, as they are described above. Computing device 301 may include a display portion 312 pivotably attached to a user display portion 314 through hinges 308a and 308b (referred to collectively as hinges 308). In other implementations, the computing device 301 may have a single hinge, or may have more hinges than illustrated.

Example computing device 301 is illustrated as being partially transitioned from a notebook-style orientation to a tablet-style orientation. As such, display portion 312 of the computing device 301 has been pivoted or rotated about the hinges 308 relative to the user input portion 314 of the computing device 301. Such a pivot or rotation is represented by example arrow 305. Further, such rotation 305 of the display portion 312 may cause the hinges 308 to each rotate relative to the user input portion 314 along example direction 303a, similar to the motion 203a of hinge 208, as discussed above.

Computing device 301 may also include a computing device accessory 304 and an accessory pivot 300 disposed within the user input portion 314. The accessory pivot 300 is illustrated as having moved the computing device accessory 304 from a stowed position, and partially towards a deployed position along example direction 303e. Referring now to FIG. 3B, a perspective view of the example computing device 301 is illustrated, wherein the display portion 312 has been fully pivoted along direction 305 about the hinges 308 relative to the user input portion 314 to dispose the computing device 301 in a tablet-style orientation, wherein a screen 322 is facing away from the rest of the computing device 301. As such, the hinges 308 have further moved relative to the user input portion, causing the accessory pivot to fully move or pivot the computing device accessory 304 along example direction 303e to the deployed position. When disposed in the deployed position, the computing device accessory 304 may extend from a side or edge of the computing device 301, or a housing thereof, such that the computing device accessory 304 can function uninhibited and/or unblocked.

Referring now to FIGS. 4A-4B, bottom or underside detail views of a computing device 401 having an accessory pivot 400 is illustrated. Example accessory pivot 400 may be similar to other example accessory pivots described above. Further, the similarly-named elements of example accessory pivot 400 may be similar in function and/or structure to the respective elements of other example accessory pivots, as they are described above. Example accessory pivot 400 may include a driven gear 402, a hinge gear 406, and a transfer bar 410. In some implementations, transfer bar 410 may include an engagement switch 428 and an axle 430. The transfer bar 410 may be rotatably disposed on the axle 430, and the axle 430 may be translatable or otherwise movable relative to the computing device 401. The engagement switch 428 may move along example direction 409 to transition the transfer bar 410 between an engaged position (illustrated in FIG. 4A) and a disengaged position (illustrated in FIG. 4B), in other implementations, the engagement switch 428 may move in a different manner in order to transition the transfer bar 410 between the engaged and disengaged positions. The transfer bar 410 may be operably engaged with the driven gear 402 and the hinge gear 406 if disposed in the engaged position. Conversely, the transfer bar 410 may not be operably engaged with the driven gear 402 and the hinge gear 406 if disposed in the disengaged position. Thus, if the computing device 401 is transitioned from a notebook-style orientation to a tablet-style orientation, as described above, and the transfer bar 410 is disposed in the engaged position, then the accessory pivot 400 will rotate a computing device accessory 404 from a stowed position to a deployed position as a display portion of the computing device 401 is rotated around a user input portion. Conversely, if the transfer bar 410 is disposed in the disengaged position, then the accessory pivot 400 will not rotate the computing device accessory 404, and the accessory will remain disposed in the stowed position within a housing of the computing device 401. In some implementations, the engagement switch 428 may be disposed, at least partially, on the exterior of the computing device 401 so that a user can selectively move the transfer bar 410 between the engaged and disengaged positions in order to engage or disengage the function of the accessory pivot 400.

Additionally, in some implementations, the driven gear 402 may be operably coaxial with the hinge gear 406. In further implementations, both the driven gear 402 and the hinge gear 406 may be operably coaxial with the axis of rotation 407 of a first pivot of the hinge 408, in other implementations, any of the driven gear 402, the hinge gear 406, and/or the first pivot of the hinge 408 may have a different axis of rotation from the others, and such a structure may enable the accessory pivot 400 to achieve desired rotation ratios and/or pivoting. function of the computing device accessory 404.

What is claimed is:

1. An accessory pivot, comprising:
a driven gear fixed to a computing device accessory;
a hinge gear engaged with a hinge of a computing device; and
a transfer bar engaged with the driven gear and the hinge gear to actuate the driven gear upon the transfer bar being actuated by the hinge gear.

2. The accessory pivot of claim 1, wherein the hinge gear is fixed to the hinge, and a motion of the hinge causes the hinge gear to actuate the transfer bar and cause the transfer bar to actuate the driven gear.

3. The accessory pivot of claim 1, wherein the computing device accessory is a camera.

4. The accessory pivot of claim 1, wherein the driven gear and the hinge gear are spur gears.

5. The accessory pivot of claim 4, wherein the transfer bar is a spur gear.

6. The accessory pivot of claim 4, wherein the transfer bar is a rack gear and the hinge gear is a pinion gear.

7. The accessory pivot of claim 1, wherein the driven gear, the hinge gear, and the transfer bar are bevel gears with complementary geometries to each other.

8. A housing for a computing device, comprising:
a hinge pivotably engaged with a first end of the housing and pivotably engaged with a base portion of a display of the computing device;
a camera rotatably disposed within the first end of the housing; and
a camera pivot disposed within the first end of the housing and comprising:
a driven gear fixed to the camera;
a hinge gear engaged with the hinge of the computing device; and
a transfer bar to actuate the driven gear and rotate the camera relative to the housing upon the transfer bar being actuated by the hinge gear.

9. The housing of claim 8, wherein the driven gear is operably coaxial with the hinge gear.

10. The housing of claim 8, wherein motion of the hinge relative to the first end of the housing is to actuate the hinge gear and cause the hinge gear to actuate the transfer bar.

11. The housing of claim 8, further comprising a an engagement switch to move the transfer bar between an engaged position and a disengaged position, wherein the transfer bar is operably engaged with the driven gear and the hinge gear if disposed in the engaged position and wherein the transfer bar is not operably engaged with the driven gear and the hinge gear if disposed in the disengaged position.

12. A computing device, comprising:
a user input portion having a keyboard and a rotatable camera disposed at a first end of the user input portion;
a hinge attached to the user input portion at the first end;
a display portion pivotably attached to the user input portion through the hinge; and
a camera pivot disposed within the user input portion, comprising:
a driven gear engaged with the camera;
a hinge gear operably attached to the hinge; and
a transfer bar engaged with the driven gear and the hinge gear to actuate the driven gear upon the transfer bar being actuated by the hinge gear.

13. The computing device of claim 12, wherein the hinge is a double pivot hinge to enable the display portion to rotate about 360 degrees around the user input portion.

14. The computing device of claim 13, wherein the hinge has a first pivot attached to the user input portion and attached to the hinge gear, and a second pivot attached to the display portion.

15. The computing device of claim 14, wherein the camera pivot is to rotate the camera from a stowed position to a deployed position as the display is rotated around the user input portion.
